(19) United States
(12) Patent Application Publication
(10) Pub. No.: US 2026/0163828 A1
(43) Pub. Date: Jun. 11, 2026

(54) SYSTEM AND METHOD FOR MONITORING AND ANALYSIS OF 5G OPEN RAN COMMUNICATION NETWORKS

(71) Applicant: DISH Wireless L.L.C., Englewood, CO (US)

(72) Inventors: Abbas Ali Khan, Aurora, CO (US); Mahdi Khansari, Littleton, CO (US)

(21) Appl. No.: 18/976,760

(22) Filed: Dec. 11, 2024

(51) Int. Cl. H04L 43/062; G10L 15/22; H04L 43/02; H04L 43/04; H04L 43/08; H04W 24/10

(52) U.S. Cl. CPC H04L 43/062; G10L 15/22; H04L 43/02; H04L 43/04; H04L 43/08; H04W 24/10; G10L 2015/223

(57) ABSTRACT

A method for monitoring performance of a 5G OPEN RAN (O-RAN) communication network includes receiving an input prompt, e.g., a text or a voice prompt, from a user interface comprising a request related to performance of the communication network, providing a response to the user interface based on the input prompt and configured to obtain additional information regarding the input prompt, receiving feedback from the user interface comprising at least the additional information, determining a set of performance data and a set of infrastructure information related to at least one of the input prompt and the additional information, retrieving the set of performance data and the set of infrastructure information from at least one database, correlating the set of performance data with the set of infrastructure information, and generating a report regarding performance of the communication network based on the set of performance data and the set of infrastructure information.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for monitoring performance of a 5G OPEN RAN (O-RAN) communication network includes a memory that stores one or more computer readable media that includes instructions one or more processor devices configured to execute the instructions of the computer readable media to: receive an input prompt from a user interface comprising a request related to performance of the communication network, provide a response to the user interface based on the input prompt and configured to obtain additional information regarding the input prompt, receive feedback from the user interface comprising at least the additional information, determine a set of performance data and a set of infrastructure information related to at least one of the input prompt and the additional information, retrieve the set of performance data and the set of infrastructure information from at least one database, correlate the set of performance data with the set of infrastructure information, and generate a report regarding performance of the communication network based on the set of performance data and the set of infrastructure information.

In accordance with another embodiment, a method for monitoring performance of a 5G OPEN RAN (O-RAN) communication network includes receiving an input prompt from a user interface comprising a request related to performance of the communication network, providing a response to the user interface based on the input prompt and configured to obtain additional information regarding the input prompt, receiving feedback from the user interface comprising at least the additional information, determining a set of performance data and a set of infrastructure information related to at least one of the input prompt and the additional information, retrieving the set of performance data and the set of infrastructure information from at least one database, correlating the set of performance data with the set of infrastructure information, and generating a report regarding performance of the communication network based on the set of performance data and the set of infrastructure information.

In accordance with another embodiment, a non-transitory, computer-readable medium storing instructions that, when executed by a processor, perform a set of functions for monitoring performance of a 5G OPEN RAN (O-RAN) communication network and the set of functions includes receiving an input prompt from a user interface comprising a request related to performance of the communication network, providing a response to the user interface based on the input prompt and configured to obtain additional information regarding the input prompt, receiving feedback from the user interface comprising at least the additional information, determining a set of performance data and a set of infrastructure information related to at least one of the input prompt and the additional information, retrieving the set of performance data and the set of infrastructure information from at least one database, correlating the set of performance data with the set of infrastructure information, and generating a report regarding performance of the communication network based on the set of performance data and the set of infrastructure information.

### BRIEF DESCRIPTION OF THE DRAWINGS

The present disclosure will hereafter be described with reference to the accompanying drawings, wherein like reference numerals denote like elements.

FIG. 1 is a schematic block diagram of an example wireless communication network in accordance with an embodiment;

FIG. 2 is a schematic block diagram of an example of a service-based architecture of a wireless communication network in accordance with an embodiment;

FIG. 3 is a schematic block diagram of a system for monitoring performance of a 5G OPEN RAN (O-RAN) communication network in accordance with an embodiments;

FIG. 4 illustrates a method for monitoring performance a 5G O-RAN communication network in accordance with an embodiment; and

FIG. 5 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

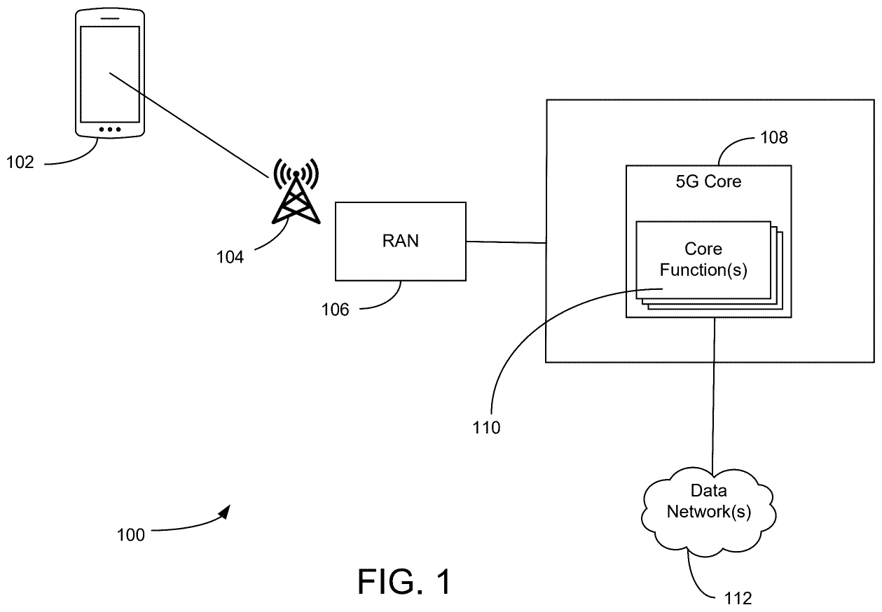

FIG. 1 is a schematic block diagram of an example wireless communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet, an enterprise data network, combinations thereof, and the like) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The communication network 100 may be used to facilitate multiple types of communication sessions, such as, for example, voice calls, video calls, messaging, data transmission, and/or other types of communications. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computer resources. Such general purpose computing resources can be part of a public clous-computing platform that provides virtual private clouds (VPCs) for multiple clients. On a hybrid cellular network, RAN components of the cellular network are in communication with components of the cellular network executed on a public cloud computing platform such as Amazon Web Services (AWS).

In some configurations, the communication network 100 may be a standalone (SA) network (e.g., a 5G SA network) that utilizes 5G cells for both signaling and information transfer via a 5G packet core architecture. However. the present disclosure may be implemented with any type of wireless communication network capable of being virtualized.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3 5G next generation base station that supports communications with the with the UE device 102. While FIG. 1 illustrates a single radio transceiver 104 and a single RAN 106, in practical implementations the communication network 100 may include any number of radio transceivers 104 and/or any number of RAN 106.

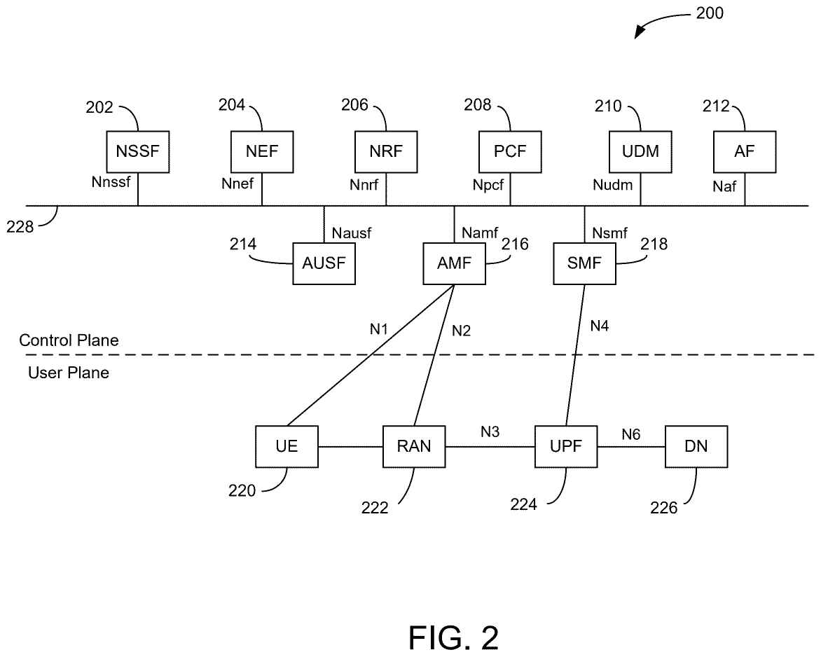

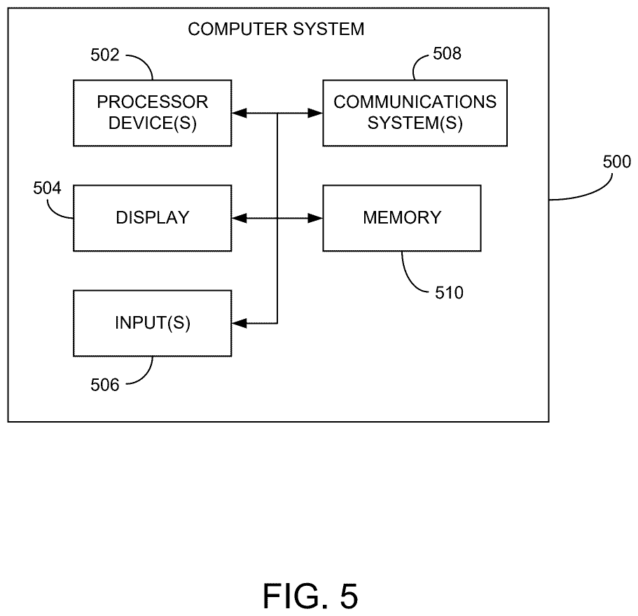

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 500 discussed below with respect to FIG. 5) such as a server or the functionality of the RAN 106, the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology (discussed further below). Within an NDC, multiple regional data centers (RDCs) can be logically present. In some embodiments, each of such one or more regional data centers may execute core functions 110 for a different geographic region or a group of RAN components.

As mentioned, in some embodiments, the communication network 100 can be configured according to a region-based topology. For example, the communication network 100 may be implemented using a cloud computing platform that is logically and physically divided up into various different cloud computing regions (e.g., AWS regions). The cloud computing regions may be based on geographical location of the gNbs; for example, the communication network 100 for a given nation may be divided into a number of geographical regions. Each of the cloud computing regions can be isolated from other cloud computing regions to help provide fault tolerance, fail-over load-balancing, and/or stability and each of the cloud computing regions can be composed of multiple availability zones or markets, each of which can be a separate data center located in general proximity to each other (e.g., within 100 miles). For example, one cloud computing region may have its data centers and hardware located in the northeast of the United States while another cloud computing region may have its data centers and hardware located in California.

FIG. 2 is a schematic block diagram of an example of a service-based architecture (SBA) of a wireless communication network in accordance with an embodiment. The SBA 200 is divided between a control plane and a user plane. The control plane includes a plurality of network functions (NFs) 202-218. The user plane includes a UE 220 (e.g., UE 102 shown in FIG. 1) in communication with a RAN 222, and NFs (e.g., UPF 224). In FIG. 2, the SBA 200 can be used for providing communication between the UE device 220 and a data network 226 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide serviced, for example, to support one or more of application function influence on traffic routing, application function influence on service function chaining, accessing the NRF 212, interacting with the PCF 216, time synchronization service, IP multimedia subsystem (IMS) interactions with the 5GC, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the communication network, and managing session context with the UPF 224. Together with the UPF 224, the SMF 218 can maintain a record of PDU session state by means of a PDU Session ID.

The SBA 200 may also include a plurality service-based interfaces (SBIs) 228 to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the RAN 222 wirelessly, for example, via a radio transceiver 104 (shown in FIG. 1). The AMF 216 and the UE 220 can communicate signals or messages with another over, for example, an N1 interface. The AMF 216 and the RAN 222 can communicate signals or messages with one another over, for example, an N2 interface. The RAN 222 and the UPF 224 can communicate signals and data with one another over, for example, an N3 interface. The SMF 218 and the UPF 24 can communicate signals or messages with one another over, for example, an N4 interface. The UPF 224 can send and receive signals and data with the Internet 226 over an Internet interface, for example, an N6 interface. The AMF 216 and the SMF 218 can communicate signals and messages with one another over an interface, for example, an N11 interface.

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Hone Subscriber Service (HSS), a Home Location Register (HLR), a Binding Support Function (BSF), a Policy and Charging Rules Function (PCRF), a Call Session Control Function (CSCF), a Session Border Control Function (SBC), a Media Resource Function (MRF), a Short Message Service Function (SMSF), or a Rich Communication Services Application (RCS).

As discussed above, a communication network can include many different infrastructure components (e.g., core 108 (including core functions 110), RAN 106, transport related components, etc.). The performance of a communication network (e.g., communication network 100 shown in FIG. 1) can be monitored, evaluated and optimized using, for example, performance data and key performance indicators (KPIs). Typically, the communication service provider (CSP) associated with the communication network can have different organizations or teams that are responsible for monitoring different components of the communication network and each team or organization may have its own tools and platforms to monitor performance (e.g., based on performance data and KPIs). Monitoring particular components or creating end-to-end analytics can require an administrator to have to manually access a number of different tools, platforms and databases and then try to piece such analysis together. This process can be inefficient and time consuming, and can produce inaccurate or unreliable results.

The present disclosure describes systems and methods for monitoring performance of a 5G OPEN RAN (O-RAN) communication network that can increase efficiency and improve the accuracy and reliability of the analysis and reports generated regarding performance (e.g., based on performance data, key performance indicators, infrastructure information) of the 5G O-RAN communication network. Advantageously, the disclosed systems and methods provide a mechanism to automatically determine the data and information needed to generate a performance report in response to an input prompt from an operator and generate a report in response to the input prompt. The disclosed systems and methods can advantageously reduce the time required to generate reports regarding performance (e.g., performance data and KPIs) including identifying performance data and infrastructure information relevant to the input prompt, retrieving the relevant performance data and infrastructure information, and processing the performance data and infrastructure information. In some embodiments, an operator can utilize the disclosed system and method for monitoring performance of a 5G OPEN RAN (O-RAN) communication network to, for example, identify and/or troubleshoot problems or issues in the communication network, for example, a quality problem with voice or data services provided by the communication network such as, for example, a dropped call, low throughput, or any other cause of customer dissatisfaction or poor customer experience. In some embodiments, an operator can also utilize the disclosed system and method for monitoring performance of a 5G OPEN RAN (O-RAN) communication network to, for example, determine whether traffic in the communication network is changing (e.g., growing or declining), determine whether there is a need to deploy additional infrastructure and if so, how much additional infrastructure and the cost, determine whether, if you do not deploy additional infrastructure, what is the risk of losing customers and the financial impact, and obtain other business development and business strategic insights.

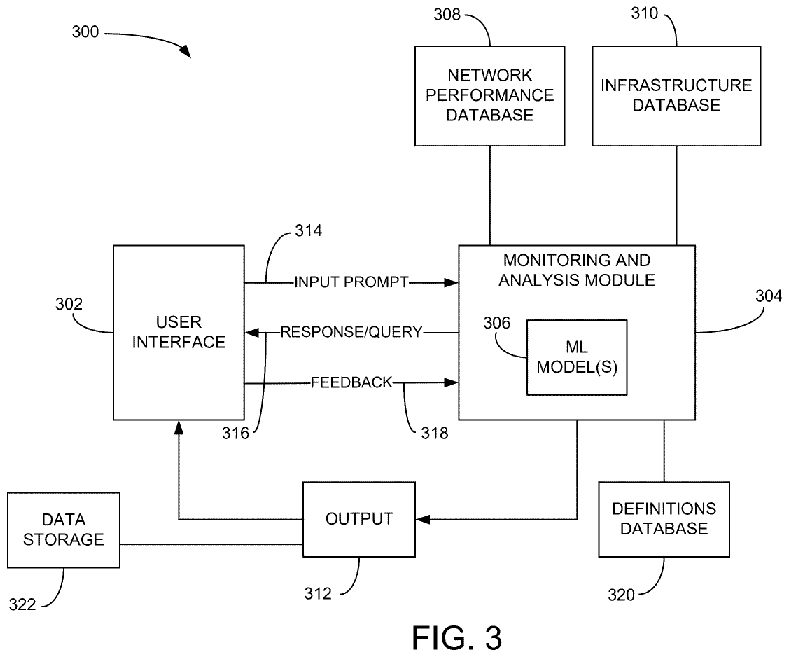

FIG. 3 is a schematic block diagram of a system for monitoring performance of a 5G OPEN RAN (O-RAN) communication network in accordance with an embodiments. The system 300 can include a user interface 302, a monitoring and analysis module 304, an optional AI/ML model 306, a network performance database 308, an infrastructure database 310, an output 312, a definitions database 320 and data storage 322. In some embodiments, the system 300 can be associated with a communication service provider (CSP) or carrier that provides communication network services using a communication network (e.g., communication network 100 shown in FIG. 1). The user interface 302 can be configured to allow an operator or administrator of a communication network (e.g., communication network 100 shown in FIG. 1) to interact with the system 300, for example, to provide inputs to the monitoring and analysis module 304 (e.g., input prompt 314, feedback 318, etc.) and to display outputs (e.g., outputs 312, response/query 316) received from the monitoring and analysis module 304. The user interface 302 (e.g., inputs 506 of a computer system 500 shown in FIG. 5) can include any suitable input devices and/or sensors that can be used to receive the user input, such as a keyboard, a mouse, a touchscreen, a microphone, a graphical user interface (GUI), a voice user interface (VOI), mechanical switches, buttons, knobs, etc. The user interface 302 can also include a display that can be used to display, for example, responses (or query) 316 from the monitoring and analysis module 304, and outputs 312 such as performance data analysis and reports generated by the monitoring and analysis module 304 (discussed further below) to an operator or administrator of the communication network. In some embodiments, the user interface 302 may be implemented on a computer system (e.g., computer system 500 discussed below with respect to FIG. 5).

In some embodiments, the inputs received from the user interface 302 can include an input prompt 314 and feedback 318. The input prompt can be, for example, a text prompt or an audio (or voice) prompt. In some embodiments, the input prompt can be configured to allow the operator to provide a request using natural language (e.g., via text or speech) that can articulate (or otherwise provide) a question or task request pertaining to a particular aspect of performance of the communication network (e.g., communication network 100 shown in FIG. 1). In some embodiments, the input prompt can include a request for information such as, for example, performance data including KPIs, as well as a type (or format) of report or analysis for the requested performance data, KPIs, etc. In some embodiments, the performance data and KPIs can include, for example, peak data rates, peak spectral efficiency, data rate experience by user, area traffic capacity, latency (user plane), connection density, average spectral efficiency, energy efficiency, reliability, mobility, mobility interruption time, system bandwidth, coverage (signal strength), network congestion, jitter, delay, etc. The report or analysis included in the request of the input prompt 314 can include, for example, a graph, a table, a chart (e.g., a pie chart), a dashboard, a histogram, a trend, a comparison between different types of performance data or metrics, etc. In one example, the input prompt 314 may be “Prepare a graph showing the mobility interruption time.” In another example, an input prompt 314 may be “Prepare a chart showing peak data rate, spectral efficiency and system bandwidth for the last 24 hours.” In yet another example, the input prompt 314 may be “What is the area traffic capacity for each availability zone?”

The input prompt 314 (e.g., a text or voice prompt) can be provided to the monitoring and analysis module 304. In some embodiments, when the input prompt 314 is a voice prompt, the monitoring and analysis module 304 can be configured to convert or translate the voice prompt to text, for example, using natural language processing (NLP). In response to the input prompt 314, the monitoring and analysis module 304 can generate a response (or query) 316 configured to, for example, confirm the request in the input prompt 314, ask follow up questions (e.g., if the request in the input prompt is not clear), and obtain additional information from the operator regarding the request. For example, the response (or query) 316 can ask the operator to confirm the particular type of performance data or KPI the operator is requesting, can request more information about the type (or format) of report or analysis (e.g., what type of chart, graphs, etc.), can request information about a time period for the requested performance data and/or report, can provide two or more options for the type of information and/or type (or format) of the report so the operator can select one of the options (e.g., the operator can select the option that most closely matches the data, report, etc. that the operator wants). In one example, for an input prompt “Prepare a graph showing the mobility interruption time,” the monitoring and analysis module 304 may generate a response 316 that asks the time period over which the mobility interruption time should be determined, whether the operator would like a mobility interruption time for the entire communication network or for a particular geographic region or area (e.g., an availability zone) of the communication network, and provides two or more options for the type of graph that can be generated to illustrate the mobility interruption time. In another example, for an input prompt “What is the area traffic capacity for each availability zone?”, the monitoring and analysis module 304 may generate a response 316 that provides multiple options for the availability zones in the communication network and asks a time period over which the area traffic capacity should be determined.

The monitoring and analysis module 304 can transmit the response (or query) 316 to the user interface 302 where it can be displayed to the operator. The operator can then provide feedback 318 via the user interface 302 to respond to the response (or query) 316 from the monitoring and analysis module 304. For example, the operator can use the user interface 302 to provide more information or select one of the options provided in the response (or query) 316. As mentioned, in some embodiments, if the response includes a plurality of options for the operator, the response can indicate that the operator should select the option that most closely matches (or resembles) what the operator is requesting. The feedback 318 (e.g., including additional information regarding the request in the input prompt 314 or an option selection) can then be transmitted to the monitoring and analysis module 304.

The monitoring and analysis module 304 can be configured to determine (or identify) network performance data and network infrastructure information related to the request of the input prompt 314 and, if provided, the feedback 318 from the operator. In some embodiments, the monitoring and analysis module 304 may determine relevant performance data and infrastructure information based on, for example, relevancy to the request in input prompt 314. As discussed further below, in some embodiments, the monitoring and analysis module 304 can determine performance data and infrastructure information relevant to the request of the input prompt using a definitions database 320. The monitoring and analysis module 304 may be configured to automatically retrieve or collect the determined relevant performance data and infrastructure information (e.g., a copy of the performance data and infrastructure information) from one or more databases, for example, a network performance database 308 and an infrastructure database 310. The network performance database 308 can include, for example, performance data (i.e., how the communication network is performing) including KPIs, data regarding any faults, alarms, issues, etc. in the communication network (e.g., the failure of a component in the communication network), service disruptions, etc. The infrastructure database 310 can include infrastructure information for the communication network, for example, an inventory of the infrastructure of the communication network (e.g., how many cell sites, the location of the cell sites, etc.) and information regarding the infrastructure components in the communication network. In some embodiments, the system 300 may include one or more application programming interfaces (not shown) that can be used by the monitoring and analysis module 304 to access and collect data from the network performance database 308 and the infrastructure database 310. For example, the monitoring and analysis module 304 can use an API call to each database 308, 312 to retrieve (or collect) the determined relevant performance data and infrastructure information. In some embodiments, the performance data and infrastructure information retrieved from the network performance database 308 and the infrastructure database 310 in response to the input prompt 314 and feedback 318 can be stored in data storage (or memory) 322.

As mentioned, in some embodiments, the monitoring and analysis module 304 can determine performance data and infrastructure information related to the input prompt 314 using a definitions database 320. The definitions database 320 can include a set of predefined definitions or rules regarding, for example, types of problems in the communication network and the associated performance data and infrastructure components for the problems, performance data associated with different metrics, recommended actions for particular problems or issues, etc. The definitions can be predefined based on, for example, domain knowledge of operators of the communication network. In some embodiments, the definitions database 320 may be a vector database which when queried may respond by identifying performance data and infrastructure information that is most similar or useful to the request of the input prompt 314. For example, the performance data and infrastructure information relevant to the input prompt can be determined (or identified) based on a similarity (or relevancy) to the input prompt 314 (and if necessary, the feedback 318). Accordingly, the monitoring and analysis module 304 may execute a search of the definitions database 320 (e.g., a vector database) based on the input prompt 314 (and, if necessary, the feedback 318). For example, in some embodiments, a predetermined similarity threshold or condition may be used and the monitoring and analysis module 304 may determine (or identify) performance data and infrastructure information by matching (or determining similarity measures between) the input prompt 314 (and, if necessary, feedback 318) to one or more entries in the definitions database 320.

In some embodiments, the monitoring and analysis module 304 can also be configured to correlate the determined performance data with the determined infrastructure data. For example, the monitoring and analysis module 304 can map the performance data to, for example, a specific cell site or sites. Once the performance data and infrastructure information is correlated, the monitoring and analysis module 304 can be configured to generate a report including, for example, the performance data, KPIs, infrastructure data, etc. related to the input prompt 314 (and, if necessary, the feedback 318) and including any appropriate analysis of the collected data and information (e.g., a graph, chart, histogram, etc.). The report can be an output 312 of the monitoring and analysis module 304 and provided to the user interface 302 to be viewed by the operator. As mentioned, in some embodiments, the report can include, for example, dashboards, usage metrics, fault and log data, charts, graphs, etc. based on the input prompt 314 (and, if necessary, feedback 318) provided by the operator. In some embodiments, the report can include one or more suggested actions.

In some embodiments, the report (i.e., output 312) generated by the monitoring and analysis module 304 can be stored in data storage 322. In some embodiments, an operator may view the report on a display of the user interface 302 (e.g., display 504 shown in FIG. 5). In some embodiments, an operator (e.g., a network administrator or engineer) may use the report, for example, to evaluate the service provided by the communication network, to identify areas for improvement, to identify issues or problems, to troubleshoot issues or problems (e.g., in response to a report or complaint by a customer), to make network planning decisions (e.g., adding new cell sites, the location of new cell sites, the parameters (or configurations) for existing or new cell sites, etc.). As mentioned, issues or problems in the communication network may include for example, a quality problem with voice or data services provided by the communication network such as, for example, a dropped call, low throughput, or any other cause of customer dissatisfaction or poor customer experience. In some embodiments, the output 312 (e.g., the report) of the monitoring and analysis module 304 can be used for reactive analysis, for example, identifying a problem in the communication network and determining the steps or actions to address the problem. In some embodiments, the output 312 (e.g., the report) of the monitoring and analysis module 304 can be used for proactive analysis, for example, looking at performance data of the communication network and determining that a problem is about to occur (e.g., a threshold has been reached) and determining the steps or actions to address the problem. In some embodiments, the output 312 (e.g., the report) of the monitoring and analysis module 304 can be used for predictive analysis, for example, the requested performance data indicates that one or more components of the communication network are approaching a certain type of activity and determining a plan to address the predicted activity.

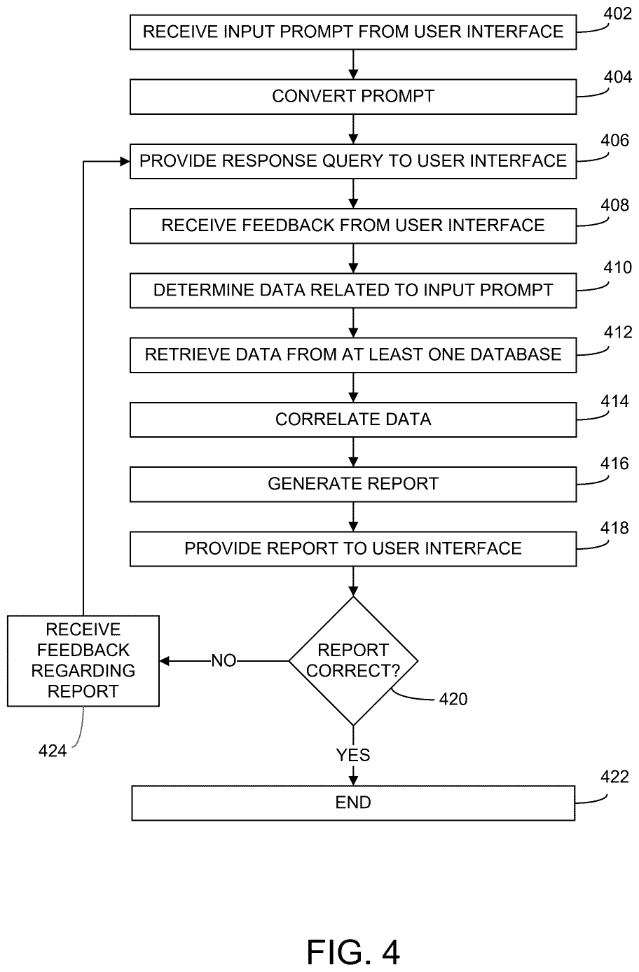

As discussed further below with respect to FIG. 4, in some embodiments, an operator can review the report and determine whether the report is correct based on the input prompt 314. If the report is not correct, the operator can use the user interface 302 to provide further feedback 318 to the monitoring and analysis module 304 indicating that the report is not correct and optionally provide a request for different information or to see the requested information and analysis in a different format, for example, to see a trend rather than a graph.

In some embodiments, the monitoring and analysis module 304 can include one or more machine learning (ML) models 306 configured (e.g., trained) to perform various functions of the monitoring and analysis module 304, for example, selection of performance data, KPIs and infrastructure information based on the input prompt 314 (and, if necessary, feedback 318), analysis of the selected performance data, KPIs and infrastructure information, generation of a report including, for example, graphs, charts, etc. The ML model 306 can also be configured to generate a response (or query) 316 from the monitoring and analysis module 304 to obtain additional information regarding the input prompt 314 as discussed above. In some embodiments, at least one ML model 306 can be a large language model (LLM). The input prompt 314, the retrieved performance data and the retrieved infrastructure information can be provided as inputs to an LLM. The LLM can be configured to generate the report (e.g., output 312) including analysis (e.g., graphs, histogram, etc.) based on the performance data and infrastructure information retrieved from the network performance database 308 and infrastructure database 310, respectively, based on the input prompt 314. Accordingly, the LLM can be trained to produce content based on the input prompt 314, performance data and infrastructure information. In some embodiments, the monitoring and analysis module 304 can also be configured to provide one or more error handling methods to for example, take care of empty or blank responses, out of range, and/or outliers.

The machine learning (ML) model(s) 306 used by the monitoring and analysis module 304 for. for example, analysis of the performance data and infrastructure information and generating a report can be, for example, decision tree learning (e.g., decision tree learning prescribed by the input prompt 314 and feedback 318 provided by an operator), association rule learning, an artificial neural network (e.g., a convolutional neural network, a generative adversarial network), inductive logic programming, support vector machine, clustering, Bayesian network, reinforcement learning, representation learning, similarity and metric learning, sparse dictionary learning, and genetic algorithms. The machine learning model 306 can be trained using known methods such as supervised learning, self-supervised learning, semi-supervised learning, etc. As one example, to perform supervised learning, the training data includes example inputs and corresponding desired (for example, actual) outputs, and the machine learning model progressively develops a model that maps inputs to the outputs included in the training data. As another example, to perform self-supervised learning, a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data).

In some embodiments, the monitoring and analysis module 304, ML model 306, network performance database 308, infrastructure database 310, and definitions database 320 may be implemented on a computer system (e.g., computer system 500 discussed below with respect to FIG. 5) such as a server. In some embodiments, the monitoring and analysis module 304 can be centralized and accessible to any authorized operator of the CSP associated with the communication network. In some embodiments, the monitoring and analysis module 304 may be implemented at a national data center or a regional data center. While FIG. 3 illustrates various components of the system for monitoring performance of a 5G O-RAN communication network, other embodiments of the system can vary the arrangement, communication paths, and specific components of the system. In some embodiments, the system can include fewer, additional, or different components in different configurations than illustrated in FIG. 3.

FIG. 4 illustrates a method for monitoring performance a 5G O-RAN communication network in accordance with an embodiment. The process illustrated in FIG. 4 is described as being carried out by the system in FIG. 3. However, in some examples, the process of FIG. 4 may be implemented by another system. Although the blocks of the process are illustrated in a particular order, in some embodiments, one or more blocks may be executed in a different order than illustrated in FIG. 4, or may be bypassed.

At block 402, an input prompt 314 may be received from an operator, for example, using a user interface 302. As mentioned, the input prompt 314 can be, for example, a text prompt or an audio (or voice) prompt and can be configured to allow the operator to provide a request using natural language (e.g., via text or speech) that can articulate (or otherwise provide) a question or task request pertaining to a particular aspect of performance of the communication network (e.g., performance data and KPIs). In some embodiments, the input prompt can include a request for information such as, for example, performance data including KPIs, as well as a type (or format) of report or analysis for the requested performance data, KPIs, etc. At block 404, in some embodiments, the input prompt can be converted (if necessary), e.g., using the monitoring and analysis module 304, to a format recognizable by a monitoring and analysis module 304. In an example, when the input prompt 314 is a voice prompt, the monitoring and analysis module 304 can be configured to convert or translate the voice prompt to text, for example, using natural language processing (NLP).

At block 406, in response to the input prompt 314, the monitoring and analysis module 304 can generate a response (or query) 316 configured to, for example, confirm the request in the input prompt 314, ask follow up questions (e.g., if the request in the input prompt is not clear), and obtain additional information from the operator regarding the request. For example, the response (or query) 316 can ask the operator to confirm the particular type of performance data or KPI the operator is requesting, can request more information about the type (or format) of report or analysis (e.g., what type of chart, graphs, etc.), can request information about a time period for the requested performance data and/or report, can provide two or more options for the type of information and/or type (or format) of the report so the operator can select one of the options (e.g., the operator can select the option that most closely matches the data, report, etc. that the operator wants). The response (or query) 316 can be provided (e.g., transmitted) from the monitoring and analysis module 304 to the user interface 302. At block 408, in response to the response (or query) 316 provided at block 406, feedback 318 can be received from the user interface. For example, the feedback can provide more information regarding the request in the input prompt 314 or provide a selection of one of the options provided in the response (or query) 316.

At block 410, performance data and infrastructure information related to the input prompt 314 and feedback 318 from the user interface 302 can be determined (or identified), for example, using the monitoring and analysis module 304. In an example, the relevant performance data and infrastructure information can be determined based on, for example, relevancy to the request in input prompt 314 (and, if necessary, the feedback 318). As mentioned above, in some embodiments, the monitoring and analysis module 304 can determine performance data and infrastructure information relevant to the request of the input prompt 314 using a definitions database 320 (e.g., a vector database). For example, as discussed above, the monitoring and analysis module 304 may execute a search of the definitions database 320 based on the input prompt 314 (and, if necessary, the feedback 318). At block 412, the identified performance data and infrastructure information can be retrieved (e.g., automatically) from one or more databases. for example, a network performance database 308 and an infrastructure database 310. As mentioned, the network performance database 308 can include, for example, performance data (i.e., how the communication network is performing) including KPIs, data regarding any faults, alarms, issues, etc. in the communication network (e.g., the failure of a component in the communication network), service disruptions, etc., and the infrastructure database 310 can include infrastructure information for the communication network, for example, an inventory of the infrastructure of the communication network (e.g., how many cell sites, the location of the cell sites, etc.) and information regarding the infrastructure components in the communication network.

At block 414, the determined performance data can be correlated with the determined infrastructure data, for example, using the monitoring and analysis module 304. At block 416, a report can be generated (e.g., using the monitoring and analysis module 304). In some embodiments, the report can include, for example, the performance data, KPIs, infrastructure data, etc. related to the input prompt 314 (and, if necessary, the feedback 318) and including any appropriate analysis of the collected data and information (e.g., a graph, chart, histogram, etc.). In some embodiments, as mentioned, the report can be generated using a machine learning model 306 (e.g., an LLM) of the monitoring and analysis module 304. In some embodiments, the generated report (i.e., output 312) can be stored in data storage 322. At block 418, the generated report (e.g., output 312) can be provided (e.g., transmitted) to the user interface 302 and, for example, displayed on a display (e.g., display 504 shown in FIG. 5) and viewed by an operator.

At block 420, if it is determined (e.g., by the operator viewing the report using the user interface 302) that the report is not correct, the operator can use the user interface 302 to provide further feedback 318 which can be received (e.g., by the monitoring and analysis module 304) at block 424. The additional feedback 318 can indicating that the report is not correct and optionally provide a request for different information or to see the requested information and analysis in a different format, for example, to see a trend rather than a graph. The process than proceeds to block 406 and a response (query) 316 can be provided to the user interface 302 (e.g., using the monitoring and analysis module 304) to, for example, confirm the request in the feedback received at block 424, ask follow up questions, and obtain additional information from the operator regarding the request. The process can then continue at blocks 408-418 to generate a new report. At block 420, if it is determined (e.g., by the operator viewing the report using the user interface 302) that the report is correct, the process can end at bock 422.

As mentioned above, various components of the communication network 100 and the disclosed system and method of FIGS. 3 and 4 may be implemented on a computer system. FIG. 5 is a schematic block diagram of an example computer system in accordance with an embodiment. The computer system 500 (e.g., a server) may include one or more processor devices 502, a display 504, one or more inputs 506, one or more communication systems 508, and memory 510. In some embodiments, processor device(s) 502 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 502 may include one or more processors, processor cores, processing elements, processor clusters, or other electronic processing units. Accordingly, a processing function described as being performed by the processor device(s) 502 may include multiple processors, processor cores, processing elements, processing clusters, etc. (of the processor device(s) 502) performing aspects or portions (sub-functions) of the processing function to complete the processing function. The one or more electronic processing units of the processor device(s) 502 may include one or more microprocessors, application-specific integrated circuits (“ASICs”), or other suitable electronic device for processing data. At least in some examples, the one or more electronic processing units of the processor device(s) 502 can be co-located physically (e.g., in the same facility, building, room, rack, or computing housing) as part of the computer system 500.

In some embodiments, display 504 can include any suitable display devices, such as a computer monitor, a touchscreen, a television, etc. In some embodiments, display 504 can be omitted. In some embodiments, inputs 506 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for monitoring performance of a 5G OPEN RAN (O-RAN) communication network. In some embodiments, inputs 506 can be omitted.

In some embodiments, communications system(s) 508 can include any suitable hardware, firmware, and/or software for communicating information over any suitable communication network (e.g., communication network 100 shown in FIG. 1). For example, communication system(s) 508 can include one or more transceivers, one or more communication chips and/or chip sets, etc. In a more particular example, communication system(s) 508 can include hardware, firmware and/or software that can be used to establish a Wi-Fi connection, a Bluetooth connection, a cellular connection an Ethernet connection, etc.

In some embodiments, memory 510 can include any suitable storage device or devices (e.g., one or more non-transitory computer readable media) that can be used to store instructions, values, etc., that can be used, for example, by processor device 502 to present content using display 504, to communicate with a communication network, to communicate with other computer systems, etc. Memory 510 can include any suitable volatile memory, non-volatile memory, storage, or any suitable combination thereof. For example, memory 510 can include RAM, ROM, EEPROM, one or more flash drives, one or more hard disks, one or more solid state drives, one or more optical drives, etc. The memory 510 may store data and/or instructions for use and execution by the computer system 500 (e.g., by the processor device(s) 502) to implement the functionality of, for example, the user interface, the monitoring and analysis module, the AI/ML model, the network performance database, the infrastructure database, the definitions database, etc. described herein. For example, the memory 510 may include or store the user interface 302, the monitoring and analysis module 304, the ML model(s) 306, the network performance database 308, the infrastructure database 310, and the definitions database 320 shown in FIG. 3, respectively. In some embodiments, the functionality described herein as being performed by the computer system 500 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for monitoring performance of a 5G OPEN RAN (O-RAN) communication network, the system comprising:
a memory that stores one or more computer readable media that includes instructions; and
one or more processor devices configured to execute the instructions of the computer readable media to:
receive an input prompt from a user interface comprising a request related to performance of the communication network;
provide a response to the user interface based on the input prompt and configured to obtain additional information regarding the input prompt;
receive feedback from the user interface comprising at least the additional information;
determine a set of performance data and a set of infrastructure information related to at least one of the input prompt and the additional information;
retrieve the set of performance data and the set of infrastructure information from at least one database;
correlate the set of performance data with the set of infrastructure information; and
generate a report regarding performance of the communication network based on the set of performance data and the set of infrastructure information.

2. The system according to claim 1, wherein the at least one database comprises a network performance database comprising performance data for the communication network.

3. The system according to claim 1, wherein the at least on database comprising an infrastructure database comprising infrastructure information for the communication network.

4. The system according to claim 1, wherein the input prompt is one of a text prompt or a voice prompt.

5. The system according to claim 1, wherein the one or more computer readable media further include at least one machine learning model configured to generate the report regarding performance of the communication network based on the set of performance data and the set of infrastructure information.

6. The system according to claim 5, wherein the at least one machine learning model is a large language model (LLM).

7. The system according to claim 1, wherein the report comprises an analysis of the set of performance data and the set of infrastructure information.

8. A method for monitoring performance of a 5G OPEN RAN (O-RAN) communication network, the method comprising:
receiving an input prompt from a user interface comprising a request related to performance of the communication network;
providing a response to the user interface based on the input prompt and configured to obtain additional information regarding the input prompt;
receiving feedback from the user interface comprising at least the additional information;
determining a set of performance data and a set of infrastructure information related to at least one of the input prompt and the additional information;
retrieving the set of performance data and the set of infrastructure information from at least one database;
correlating the set of performance data with the set of infrastructure information; and
generating a report regarding performance of the communication network based on the set of performance data and the set of infrastructure information.

9. The method according to claim 8, further comprising:
receiving report feedback regarding the report regarding performance of the communication network and comprising an indication that the report is not correct; and
generating a second report regarding performance of the communication network based on the report feedback.

10. The method according to claim 8, wherein the input prompt is one of a text prompt or a voice prompt.

11. The method according to claim 8, wherein determining a set of performance data and a set of infrastructure information related to at least one of the input prompt and the additional information comprises comparing the input prompt to a definitions database.

12. The method according to claim 11, wherein the definition database is a vector database.

13. The method according to claim 8, wherein generating a report regarding performance of the communication network based on the set of performance data and the set of infrastructure information comprises applying at least one machine learning model to the set of performance data and the set of infrastructure information.

14. The method according to claim 13, wherein the at least one machine leaning model is a large language model (LLM).

15. A non-transitory, computer-readable medium storing instructions that, when executed by a processor, perform a set of functions for monitoring performance of a 5G OPEN RAN (O-RAN) communication network, the set of functions comprising:
receiving an input prompt from a user interface comprising a request related to performance of the communication network;
providing a response to the user interface based on the input prompt and configured to obtain additional information regarding the input prompt;
receiving feedback from the user interface comprising at least the additional information;
determining a set of performance data and a set of infrastructure information related to at least one of the input prompt and the additional information;
retrieving the set of performance data and the set of infrastructure information from at least one database;
correlating the set of performance data with the set of infrastructure information; and
generating a report regarding performance of the communication network based on the set of performance data and the set of infrastructure information.

16. The non-transitory, computer-readable medium according to claim 15, wherein the input prompt is one of a text prompt or a voice prompt.

17. The non-transitory, computer-readable medium according to claim 15, wherein determining a set of performance data and a set of infrastructure information related to at least one of the input prompt and the additional information comprises comparing the input prompt to a definitions database.

18. The non-transitory, computer-readable medium according to claim 15, wherein generating a report regarding performance of the communication network based on the set of performance data and the set of infrastructure information comprises applying at least one machine learning model to the set of performance data and the set of infrastructure information.

19. The non-transitory, computer-readable medium according to claim 15, wherein the report comprises an analysis of the set of performance data and the set of infrastructure information.

20. The non-transitory, computer-readable medium according to claim 15, wherein the at least one database comprises a network performance database comprising performance data for the communication network and an infrastructure database comprising infrastructure information for the communication network.
